(19) United States
(12) Patent Application Publication
(10) Pub. No.: US 2016/0139737 A1
(43) Pub. Date: May 19, 2016

(54) APPLICATION CONTAINERS AND APPLICATION CONTAINER GENERATOR

(71) Applicant: Microsoft Technology Licensing, LLC, Redmond, WA (US)

(72) Inventors: Grad Conn, Mercer Island, WA (US); Michael Marchand, Issaquah, WA (US)

(21) Appl. No.: 14/540,110

(22) Filed: Nov. 13, 2014

(51) Int. Cl. G06F 3/0482; G06F 3/0484; G06F 3/0481

(52) U.S. Cl. CPC G06F 3/0482; G06F 3/0481; G06F 3/04842

(57) ABSTRACT

Application containers, displayed on a display of a computing device, organize essential applications and other data that a user needs into a single view. An application container can include only the most important applications and data for a user's specific role. Using a nested file directory, application containers create role-based mini start screens composed of tiles that when activated launch nested application containers and different types of applications and that can display various static and dynamic data. Application containers can filter, share, and display tiles and data based on the user's role. Application containers can also create reports and graphs based on data underlying each application container. Some application containers are generated by using an application container generator.

### BACKGROUND

The amount of data in the world has exploded in recent years. Searching for and finding the right information for a particular purpose is a common every day task for both productivity workers and casual computer users. Many computer users, especially those who use mobile computing devices, spend much time searching for an appropriate computer application or app (an application designed for a single purpose) to complete a particular task. With the continually increasing amount of information and available applications it is likely that workers and consumers alike will spend a large amount of time searching.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Application containers, displayed on a display of a computing device, organize essential applications, apps, Web apps, and other data that a user frequently needs into a single view. Using a nested file directory structure, some application container implementations are configured as one or more nested groupings of tiles arranged in grids on the display of a computing device. When one of these tiles is selected by a user another application container or an application or app is launched or displayed. Application containers can filter, share, and display tiles and data based on the user's role. Some application container implementations provide role-based access to both grid tiles and underlying data sources.

### DESCRIPTION OF THE DRAWINGS

The specific features, aspects, and advantages of the disclosure will become better understood with regard to the following description, appended claims, and accompanying drawings where:

FIG. 1 depicts an exemplary application container implementation as accessed from the start screen of a computing device.

FIG. 2 depicts an exemplary application container implementation as displayed on the screen of a computing device in a kiosk mode.

FIG. 3 depicts a system for practicing one exemplary implementation for using an application container as described herein.

FIG. 4 depicts a flow diagram of an exemplary process for using an application container as described herein.

FIG. 5 depicts a flow diagram of another exemplary process for using an application container as described herein.

FIG. 6 depicts yet a flow diagram of yet another exemplary process for using an application container as described herein.

FIG. 7 depicts an exemplary process for creating an example application container using an application container generator as described herein.

FIG. 8 is a schematic of exemplary computing environments which can be used to practice various implementations of application containers.

### DETAILED DESCRIPTION

In the following description of application container implementations, reference is made to the accompanying drawings, which form a part thereof, and which show by way of illustration examples by which the application container implementations described herein may be practiced. It is to be understood that other embodiments may be utilized and structural changes may be made without departing from the scope of the claimed subject matter.

### 1.0 APPLICATION CONTAINERS

The following sections provide an introduction and overview of the application container implementations described herein, as well as advantages that can be realized by using application containers.

As a preliminary matter, some of the figures that follow describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

### 1.1 Introduction

In general, application containers include tile groupings and grid tiles displayed on the display of a computing device. Live, static and snap tiles accessible from the grid tiles can display static and dynamic data when activated and can launch nested application containers as well as various applications and data, such as, for example, enterprise applications, apps, pinned links, Web apps, desktop applications and other information. Tile groupings of an application container are built with grid tiles that can display streaming information, but are not repositionable on the display by a user. Application containers can be nested within each other by employing a parent-child relationship between tiles of the application containers.

Any application designed to run on a desktop computer can also launch and run in an application container. However, besides being usable on desktop computing devices, application containers can run on various mobile computing devices and mobile operating systems, such as, for example, mobile phones, tablet computing devices, laptop computers, wearable devices, and vehicles, amongst others.

Some implementations of application containers are deployed and automatically updated through an app store (an online location where users can download applications or apps over a network such as, for example, the Internet).

Application containers can be generated by an application container generator that allows a user to use an application container generator wizard to create and configure application containers based on a set of application container templates, user profiles and roles, desired applications and other data and configuration information, among other things.

### 1.2 Overview

More particularly, application containers are implemented in an application container application. Application containers can organize essential apps, applications and data that a user needs into a single view. This can be done right from the fabric of an operating system (such as, for example, Microsoft Corporation's Windows® 8 operating system). Using a nested file directory, application container implementations can create nested role-based mini start screens.

Some implementations of application containers are accessed by selecting a live tile displayed on a main start screen on the display of a computer operating system. In some implementations live tiles are a key part of the main start screen. They are typically repositionable on the display and provide up-to-date content and notifications related to applications or apps underlying the corresponding live tile. Live tiles are typically updated frequently and display summary information from the underlying application. Using live tiles, users can see updates and real-time information from their apps and applications all from their start screen, enabling them to quickly review new information and engage with apps even before they open the apps.

Some application container implementations include only the most important applications and data for a user's specific role, represented by tiles grouped on the display of a computing device. In some implementations, each tile in a tile grouping is an app's representation and it can be either static or live. A static tile displays static information or default content, which can be, for example, a full-tile logo, an image or other static information. A live tile, however, displays dynamic information that invites the user to re-engage with the app or application underlying the live tile. Some application container implementations employ snap tiles in addition to live and static tiles. Snap view tiles can act as either static or live tiles but instead of navigating to another view when clicked, they open external applications such as, for example, a browser, an email program, a word processing program or spreadsheet, in a filled view and the content of the tile moves to an adjoining (snap) view. In some application container implementations, each snap view tile has an associated Uniform Resources Locator (URL). The URL identifies which external application to open via a URL type and file extension that is mapped to applications by the operating system. For example, if the URL begins with http:// the operating system will attempt to open a browser in the filled view. It should be noted, however, other types of links to applications, apps and data can be used besides URLs by leveraging other protocols.

The simplicity of an application container lies in these organizing tools: tile groupings and grid tiles. As discussed above, application containers are composed of tile groupings. Tile groupings are built with grid tiles, similar to live tiles in that they can display streaming information. However, grid tiles are not repositionable on the display of a computing device by the user.

Application containers can launch any type of application that can run on the operating system of the computing device that hosts the application container. For example, application containers can launch enterprise-specific applications (also referred to as embedded apps) or proprietary applications. These enterprise-specific applications can be embedded at the operating system (OS) level. Applications and apps can also launch and run in an application container. Relevant links (for example, URLs) can be pinned inside an application container just as a user would pin a link on a computing device's start screen for easy access. Any application designed to run in desktop mode on a desktop operating system can also launch and run in an application container.

Application containers can extend to the mobile environment (e.g., Microsoft Corporation's Windows® environment)—such as, for example, by employing the application containers on a mobile phone, a tablet computing device, a wearable computing device, a vehicle and so forth. Application containers can be designed to run everything found in a desktop computer's operating system on a mobile operating system.

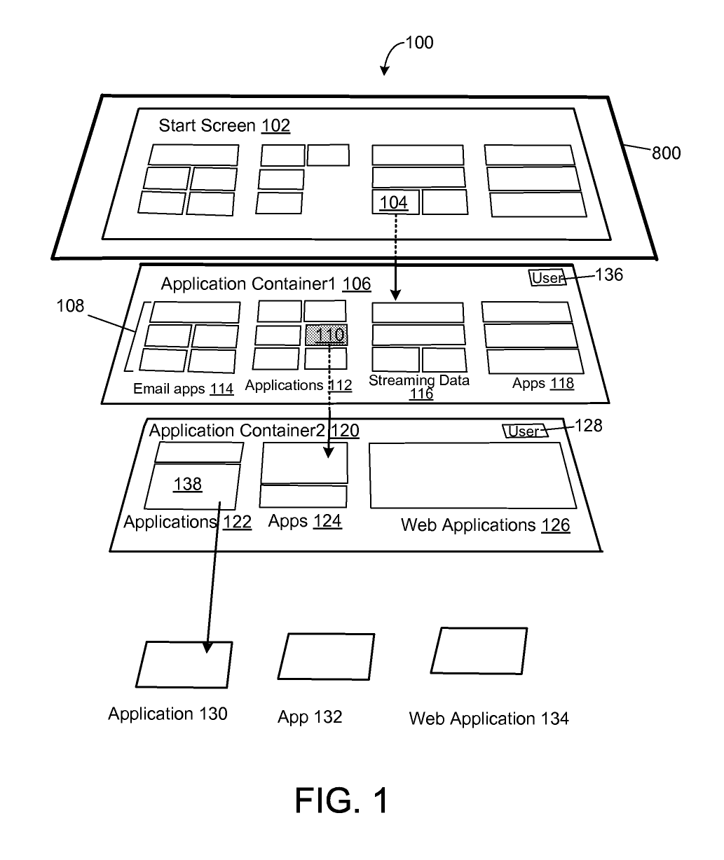

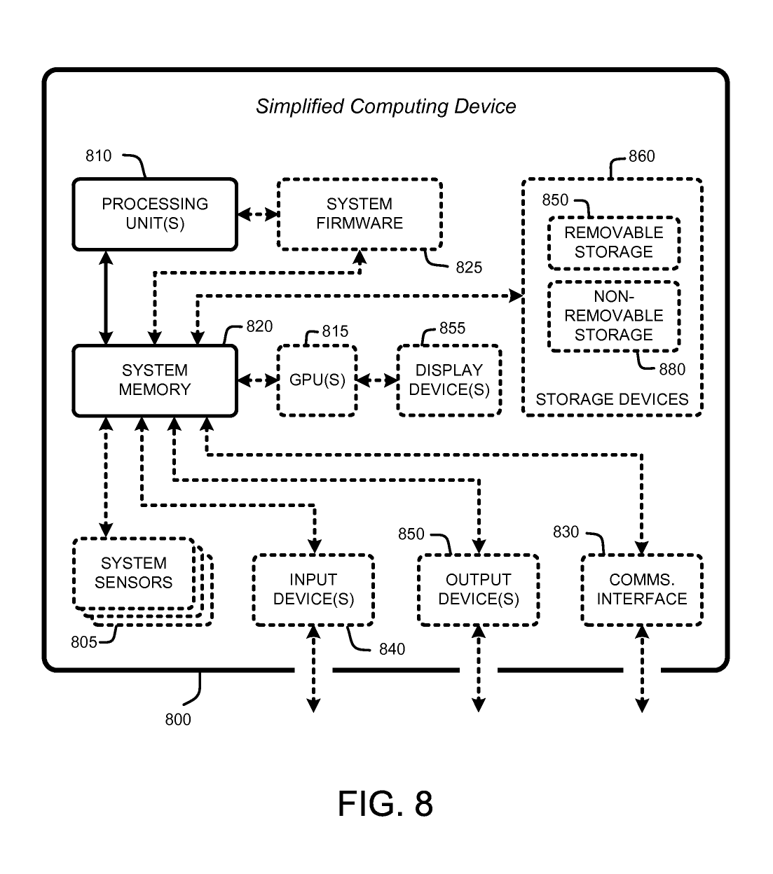

FIG. 1 provides an exemplary application container implementation 100 that is accessed from the start screen 102 of a computing device 800 (which will be discussed in greater detail with respect to FIG. 8) by activating a live tile 104 displayed on the start screen. Once activated an application container (for example, Application Container 1 106) is displayed as a set of grid tiles 108. These grid tiles can be live tiles, static tiles or snap tiles, as discussed above. This Application Container 106 can display and launch various applications 112, such as email programs 114, as well as streaming data 116 and other apps 118. When a tile 110 in an Application Container 1 106 is selected, it can also execute another application container (e.g., Application Container 2 120) that can display additional groupings of tiles 122, 124, 126 that are related to Application Container 1 106. Hence, Application Container 1 106 has a parent-child relationship with Application Container 2 120. Selection of a tile 138 from Application Container 2 120 can launch an application 130, an app 132, a Web application 134, the streaming of dynamic data, the display of static data, and the like. It should be noted that the user's identification is displayed in a small window 136, 128 on each application container. In some implementations, the tiles that are displayed in each application container, and the application containers displayed, are a function of the role of the user that is displayed in the window 136, 128. For example, a company's executive might have access to more tiles and application containers than a worker might have. Or a teacher might have access to more tiles and application containers than a student might have.

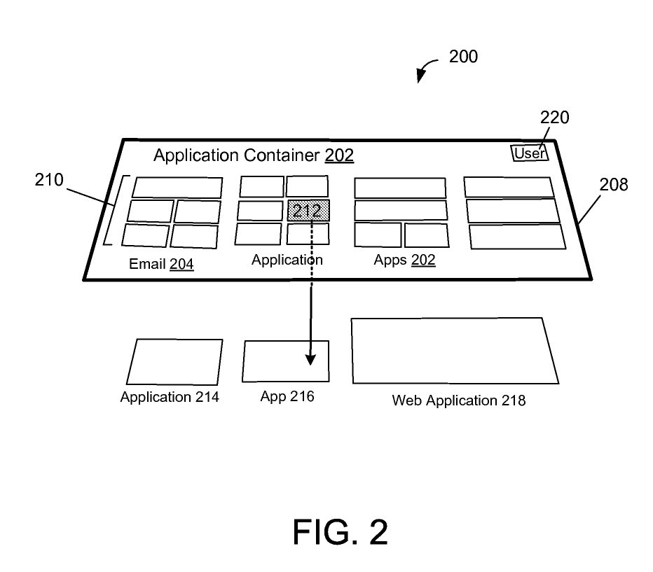

FIG. 2 provides another example implementation 200 of an application container implementation that is not accessed from the start screen of a computing device, but is accessed in a kiosk configuration. Application Container 1 202 is displayed on a hub screen 208 as a set of grid tiles 210. As discussed above, these grid tiles can be live tiles, static tiles or snap tiles. Selection of one of these tiles 212 can bring up another application container (not shown) related to the application container accessed from the hub screen (Application Container 1 202) or can launch an application 214, an app 216, a Web application 218, the streaming of dynamic data, the display of static data, and the like (anything that can run on the operating system). It should be noted that the user's identification 220 is displayed in a small window of the application container. The tiles that are displayed in the application container are a function of the role of this user, as is access to the underlying data.

Some implementations of application containers are deployed and automatically updated through a corporate app store or consumer app store. A corporate app store can be designed to support downloading or the user can access the consumer app store that is an online store for purchasing and downloading other software applications and apps over a network. By administering application containers in a corporate or consumer app store, users can easily access business and consumer apps.

As discussed previously, application containers filter information relevant to the user's role—sometimes in a single view. Furthermore, application containers filter, share, and display data on live tiles, based on the user's role. The user can stay focused on the specific tools and information needed to do his or her job. To accomplish this, in some implementations, application containers tap the power of a directory service to provide role-based access to both grid tiles and back-end data sources.

In some implementations, the directory service is included with the operating system of the computing device the application container application is running on as a set of processes and services. A domain controller authenticates and authorizes all users and computers to a given domain type network—assigning and enforcing security policies for all computers and install or updating software. For example, when a user logs into a computer that is part of a domain, the directory service checks the submitted password and determines the privilege level and/or role of the user. One such directory service that can be used with application container implementations in Microsoft Corporation's Active Directory® (AD), a directory service that Microsoft developed for Windows® domain networks and that is included with most Windows® Server operating systems as a set of processes and services.

In some application container implementations the above-discussed directory service is used to unlock the power of role-based application container access and to unlock the power of a computing cloud with identity services. For example, this enables users to work from virtually any location using any device, for example, one using Microsoft Corporation's Windows® operating system, or other operating system. It gives them always-on access to all their work resources using a single set of credentials protected with multi-factor authentication. After a user has signed in, he can get single sign-on access to his applications and data directly in his application container. For example, the directory service can be used at a global scale to centrally manage employees' access and provide single sign-on to corporate services (such as, for example, Microsoft Corporation's AZURE™ and Office 365™), and thousands of cloud applications.

Application containers can be integrated into an enterprise's existing infrastructure. Application containers can run within corporate firewalls to connect directly to and leverage services in an existing on-premises infrastructure. Examples of existing services can be corporate application services, content management services, web services, file shares, or data services layers.

An additional service layer can be created for the application container to facilitate integration of services and/or data sources across an existing corporate infrastructure. For example, an application container service layer can be deployed to and run in a cloud computing service such as, for example, Microsoft Corporation's AZURE™ Cloud. Corporate data sources can be copied or moved into the cloud service as well, which can minimize or eliminate the need to invest in additional on-premises infrastructure. The application container can be connected directly to and integrate with other third-party services in the cloud computing service.

An application container service layer can also be deployed within the on-premises infrastructure without using a cloud computing service.

To understand the simplicity of an application container, take for example an application container that organizes life for a general manager of an advertising agency. From her start screen, each application container can represent a client. Drilling down, further application containers can represent business units within each client. Included in each application container are the most relevant data and apps for her role with that client or project.

One exemplary working application container consists of 6 grid tile groupings and 32 grid tiles which aggregate data from 29 systems and 11 data sets. The result is an application that provides users with everything they need for their job in a single view. Importantly, this application container integrates data and apps/applications on the screen for a fast and fluid user experience.

### 1.3 Application Container Advantages

Application containers provide many advantages. Application containers simplify finding a particular application or app installed on a computing device. The nested structure of application containers avoids the need for extensive scrolling through these apps on the screen of a computing device as is common today in mobile operating systems.

Application containers are also advantageous in that they improve computing device usability by consolidating applications and data that a user needs to do his most important tasks into a single view. Since the user searches less for the information and applications he needs, this increases the user's speed in completing tasks. This also reduces processing load on the computing device and thus provides energy savings. Nested application containers also require less space for displaying on a graphic user interface (GUI) allowing them to be displayed on smaller and smaller devices.

Further advantages include operating system (OS)-level interoperability of applications and data, app store administration and role-based control of the data that is displayed and accessible. These advantages are discussed in greater detail below.

OS-Level Interoperability:

If an object runs on an operating system, such as for example, Microsoft Corporation's Windows® operating system, it can run in an application container. Application containers can include anything that will run on an operating system, such as, for example, pinned links, modern apps, desktop applications, embedded apps and so forth. As a result, application containers are able to provide anywhere, anytime secure access on any device that runs on the operating system.

App Store Administration:

Application containers can simplify app management by enabling deployment and updates of application containers through an app store, such as, for example, a corporate app store or consumer app store.

Role-Based Control:

As discussed previously, application containers provide role-based access to both the grid tiles and the back-end data sources. Application containers can filter, share, and display tiles and data based on the user's role to keep them focused and provide them the tools needed to do their job.

### 2.0 DETAILS

The following paragraphs provide details of various application container implementations.

### 2.1 Security

For many organizations, security is extremely important, and many organizations already have security mechanisms in place. The application container implementations discussed herein can leverage these existing security services. In some implementations, a directory service is used to provide security processing in application container implementations. One such directory service that can be used with application container implementations described herein is Microsoft Corporation's Active Directory®. In some application container implementations, a computer joined to the domain of the directory service can offer a single sign-on experience.

### 2.2 User Interface Capabilities

As discussed previously, application containers are sometimes presented in a hub view. Tiles in an application container can be grouped based on related functionality. Tiles can be static, live and snap. These user interface constructs are described in more detail below.

2.2.1 Hub View

In some implementations, the main view of an application container is the hub view, which consists of groups of tiles and functions as a home page. The hub view does not replicate a desktop display. It provides the look, feel, and some of the functionality of the main start screen in a format tailored for a company's or user's unique needs. The tiles connect to and display information from sources that are important to a user given the user's particular role, such as, for example, internal systems and applications, external systems and applications, Internet pages, and other applications and data sources.

2.2.2 Groupings-Based on Related Functionality

Tiles that have related functionality in the application container are arranged in groups. In some implementations, each group has a heading and the associated tiles are aligned in a grid below this heading. For example, tiles can be grouped in a 2-column, 3-row grid which works well in many resolutions.

2.2.3 Tiles

As discussed above, in some implementations, application container tiles are one of three display types: static, live, and snap. Each of these types of tiles when activated launches a new display. For example, static tiles when activated (e.g., touched on a touch screen display or selected with a cursor) display static information, such as, for example, a static image, a logo or other information. Live tiles when activated (e.g., touched on a touch screen display or selected with a cursor) can display dynamic data, such as, for example, a rotating list of data or images, a video, graph reports, or grid reports. Static and live tiles, when activated, navigate to another view within the application container application (such as a graph report view or grid report view). Snap view tiles can act as either static or live tiles but instead of navigating to another view when selected by a user (e.g., clicked with an input device or touched on a touch screen), they open external applications such as, for example, a browser, an email program, a word processing program or spreadsheet, in a filled view and the content of the tile moves to an adjacent (snap) view. In some application container implementations, each snap view tile has an associated URL. The URL identifies which external application to open via a URL type and file extension that is mapped to applications by the operating system. For example, if the URL begins with http:// the operating system will attempt to open a browser in the filled view.

2.2.4 Tile Sets

A tile set is a set of report views that are represented by a single tile (for example, on the hub view display of an application container). The tile that visually represents the tile set is the navigation starting point for one or more associated report views based on a single data set. For example, a live tile on the hub view can present a subset of a data set in a minimal mode and provide an indication of the underlying data set. The data set can be presented in a dynamic graph and in a grid format.

2.2.5 Report View Types

A report view is a specific format used to render data in a meaningful and useful way for the user. In some application container implementations, the three report view types available in an application container are list, graph, and grid. These are further explained in the paragraphs below.

2.2.5.1 List Report View:

List Report views are used to display one or more data points in a simple list. One use for a list view is to display a small set of data points on a live tile.

2.2.5.2 Graph Report View:

Graph views organize data in a chart-style format. Various graph report chart types can be displayed. Bar charts can be presented in a graph view for example. Additionally, waterfall charts can be presented in a graph view. Waterfall charts are normal stacked charts where some of the series are defined with a transparent color so some of the bars appear to not start from the bottom of the Y-axis. This expands a stacked bar to look as though it is cascading across the chart. Another chart type that can be presented is a pie chart.

Graphs can be dynamic; for example, a user can drill down into a displayed chart by selecting a specific segment in the displayed chart (in one implementation a user can drill up by selecting a back button displayed on the display).

2.2.5.3 Grid Report View:

The grid report view organizes data into rows and columns. A grid report view displays grid controls to allow a user to manipulate and search the data underlying the report view. For example, grid controls can provide many useful features for the user such as grouping, ordering, searching, and row or column selection.

2.2.5.4 Deep Link:

Grids can be configured to open a snap view when specific data is clicked in the grid. For example, if the grid contains data from a customer relationship management (CRM) application, the user can select an opportunity ID and the application container will open the CRM application (in a browser) at that specific opportunity instead of landing on the home page of the CRM application. This is a deep link. In this example, when the browser opens to show the details for a selected opportunity, the full grid report view reconfigures to show a subset of the grid to one side—for instance, opportunity ID, company name, forecast type, and forecasted revenue. The grid remains active and the user can scroll to another opportunity, click that row, and the browser will show the newly selected opportunity. To return to the full grid, in one implementation, the user closes the browser window.

2.2.5.5 Auto Scroll to Grid

Because the graph and grid views link to the same data set, automatic navigation between the two views is possible. As an example, if a user has drilled down to the lowest level of detail in a stacked bar chart and clicks (e.g., with an input device) on the chart bar, an application container can automatically scroll to the corresponding grid view.

2.2.5.6 Navigating to the Home Page

A user can return directly to the hub view from within graph or grid views. For example, this can be done by displaying a menu bar and selecting a Home icon or button.

2.3 Filters

Application containers allow for the filtering of underlying data sets. For example, filters set parameters for a query to extract only the data which the user wants to see. There are two main types of filters related to application containers: global and local. These are described in greater detail in the paragraphs below.

2.3.1 Global Filters

Global filters determine the data sets that are used for all views across an application container. Application containers support the concept of having a hierarchal relationship between global filters. For example, in an application relating to an education system, location data can be grouped into specific school locations, the specific school location data can be grouped into school districts, school district data can be grouped into regions, and regional data can be grouped into states or countries. Thus, if a user selects a specific school district, only the data for that school district is displayed on any view. Data about schools in other school districts would not be displayed.

Global filters act on all data across an application container. The data level of a graph is the data domain for which the graph displays information. Changes to the global filters affect all reporting data sets.

In one application container implementation, a user can set the global filters by accessing a menu bar on the display, selecting a menu item (e.g., called “Global Filters”), making selections in an expanded menu that pops up, and selecting an Apply button. If a group has more than one data point, the user can select more than one global filter (or All). For example, if a user selects one district, the graphs and grids will show all the schools within that school district. If the user selected two districts, the graphs and grids would show the schools for both districts.

Users can select portions of a graph or data in a grid or chart to “drill down” into the underlying data. In this case a drill down filter is applied. Whenever a drilldown filter or a global filter is applied, an application container can apply a set of logic rules. Because one dataset underlies a tile set, these filters can change both the graph view and the grid view and keep the graph and the grid synchronized.

2.3.2 Drill Down and Drill Up

To support the drill-up/down capability in some application container implementations, a hierarchy of data domains must exist. An example of a typical data domain hierarchy is geography. For example, a geographical hierarchy could consist of multiple data domains such as region, district, with single location as the lowest level of pertinent data in the hierarchy. In graph views, users drill through the levels of a domain hierarchy. This special domain hierarchy is also a part of the global filters. Thus, drilling up or down is equivalent to manually changing a global filter for that domain hierarchy. This special domain hierarchy is also referred to as the drilldown filters. Some application container implementations can support only a single data domain hierarchy for drilling up and down. If the underlying data source is built on a hierarchy such as the geographic breakdown of sales territories from region to sales territory, this hierarchy can support an application container that includes the capability to drill down or up (moving between the levels of a hierarchy). A user can drill up or down using two methods: (1) changing the global filters or (2) by selecting segments within a graph to drill down and by selecting a Back button to drill up. The global filters work in tandem with drilling up/down within a graph or a grid. Changing one changes the other. Providing these two methods gives the user two ways to analyze data. Global filters can be used when a user wants to see a specific data point and knows where it resides in the hierarchy—for example, the current quarter's sales for one sales territory. Moving within a graph can be used when a user wants an overall view or does not know where the data point resides.

2.3.3 Local Filters

Local filters apply only to the components of a single tile set (for example, a tile set with a live tile, a graph tile, and a grid tile).

2.3.4 Filters Persistence

In some implementations, an application container persists the global and local filters the user has selected, so the filters are remembered the next time the application container application is started.

2.4 Privilege

Some application container implementations grant access to and display data based on user privilege. For example, the data sources grant access to users that reside in specific directory services security groups. Some of the data sources grant users access to all data. Other data sources restrict users' data access to only specific data (e.g., at the row level in a grid report). In these cases, different security groups are granted access to different data through filtering that is applied at the database.

2.4.1 Role-Based Views

An application container provides the ability to filter, share, and display information based on role. The user experience changes, based on the role of the currently logged-in user. This may include showing, hiding, or reorganizing tiles; configuring default settings; or preapplying filters. For example, the views and data presented can be based on a user's job level. In one scenario, an application container grants executives (who are members of a specific directory service security group) access to a tile that displays sensitive data. Members of all other security groups will not see that tile. In this example, the user's role determines which data is displayed. In one implementation when an application container is launched, the user's role is determined in order to determine the user's access to application containers, tiles and data. The user's access is checked against the directory service and a user role is returned to the client application. The application container inspects the user role to determine which tiles the user can view along with other role-specific customizations.

2.5 Creating Tiles and Groups

Tiles and groups are generated as observable collections that are bound to the grid view. In some implementations, this collection contains the tile title, template, and group name, etc. In some implementations, each tile has its own XAML template so individual tiles can be modified without affecting other tiles. In some implementations, the tile structure and tile content are maintained separately so an organization can have a single hub view structure across all application containers in the organization.

2.6 Dynamically Configurable Tiles

Tiles can be dynamically defined and configured. In some application container implementations, an XML file defines the tile name, group name, URL that will be opened when the user clicks that tile, tile order, tile color, tile icon, etc.

2.8 Offline Capability

Much of the functionality of an application container can be designed to work when the computing device hosting the application container application is offline (e.g., not connected to a network). One approach to accomplish this is to download and store, on the device, the data sets that hold all the data that underlies all reports designed into an application container. This allows users to continue to view their data when network and Internet access is slow or unavailable. Another advantage to storing data offline is that the data can be made quickly available to report views, making the application very responsive.

### 3.0 AN EXEMPLARY SYSTEM

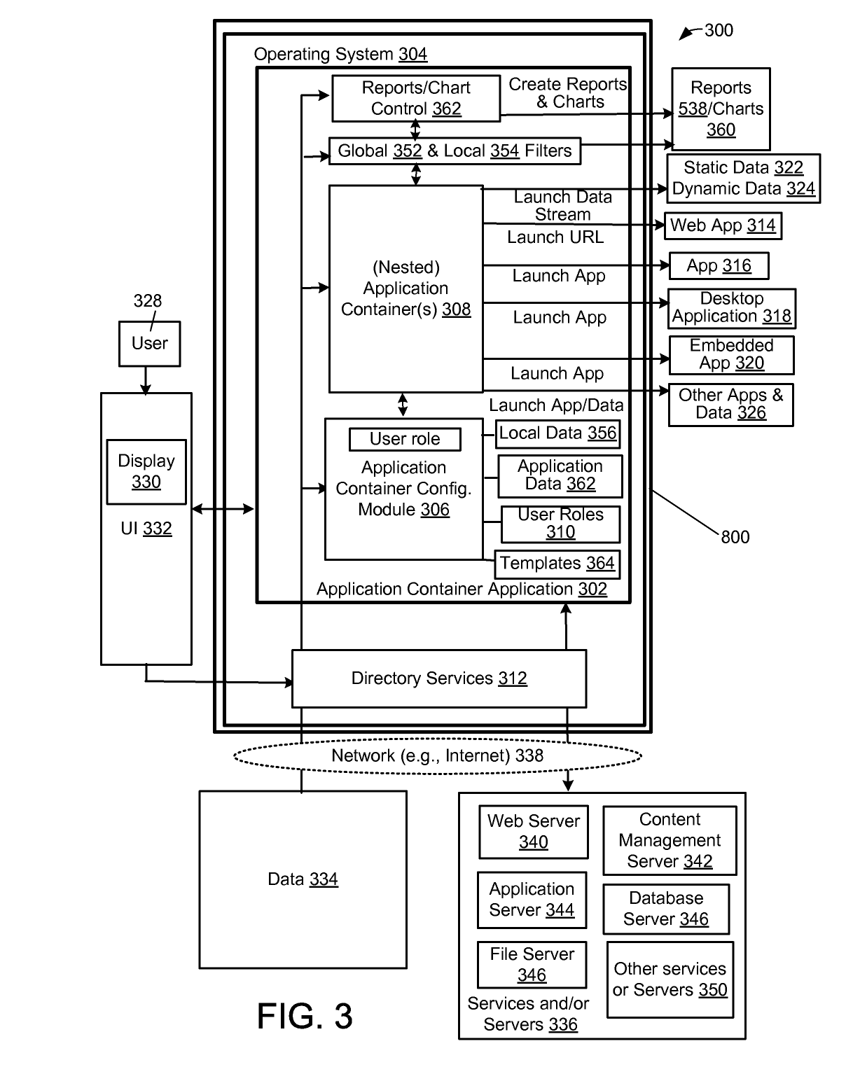

FIG. 3 depicts an exemplary system 300 for practicing application container implementations as described herein.

As shown in FIG. 3, an application container application 302 resides on a computing device 800, such as will be described in greater detail with respect to FIG. 8. The application container application 302 runs on an operating system 304 of the computing device 800. The application container application 302 further has an application container configuration module 306 that configures application containers 308 that are created and displayed based on user roles 310 that are determined by a directory service 312. The application container configuration module 306 can use application data 362, application container templates 364, along with user roles 310 to configure one or more application containers for a given user. These application containers 308 can be nested within each other and each can launch one or more applications (e.g., Web applications 314, apps 316, desktop applications 318, embedded applications 320, and other static 322 and dynamic data 324, as well as other types of applications) when tiles of an application container are selected by a user 328 from a display 330 of the computing device 800 via a user interface 332. The application containers can use data 334 and services 336 obtained over a network 338, such as, for example, the Internet. These services can be those provided by a Web server 340, a content management server 342, an application server 344 (such as for example, an app store), a file server 346, a database server 348 and other servers or service 350.

The application container application 302 can also apply global filters 352 and local filters 354 to the application containers 308 in order to filter local data 356 and data 334 received over the network 338, as previously discussed. Furthermore, reports 538 and charts 360 can be generated by a report/chart module 362 using this data with or without the filters 352, 354 being applied to the data 356, 334.

It should be noted that application containers can be integrated into an enterprise's existing infrastructure. Application containers can run within corporate firewalls to connect directly to and leverage services in an existing on-premises infrastructure. Examples of existing services could be corporate application services, content management services, web services, file shares, or data services.

In addition, application containers can be used to integrate services and/or data sources across an existing corporate or organization infrastructure. The application containers can be deployed to and run in a cloud computing service such as, for example, Microsoft Corporation's AZURE™ Cloud. Organization or corporate data sources can be copied or moved into the cloud service as well, which can minimize or eliminate the need to invest in additional on-premises infrastructure. Application containers can also connect directly to and integrate with other third-party services in the cloud.

### 4.0 EXEMPLARY PROCESSES

The following paragraphs discuss exemplary processes for practicing some implementations of application containers.

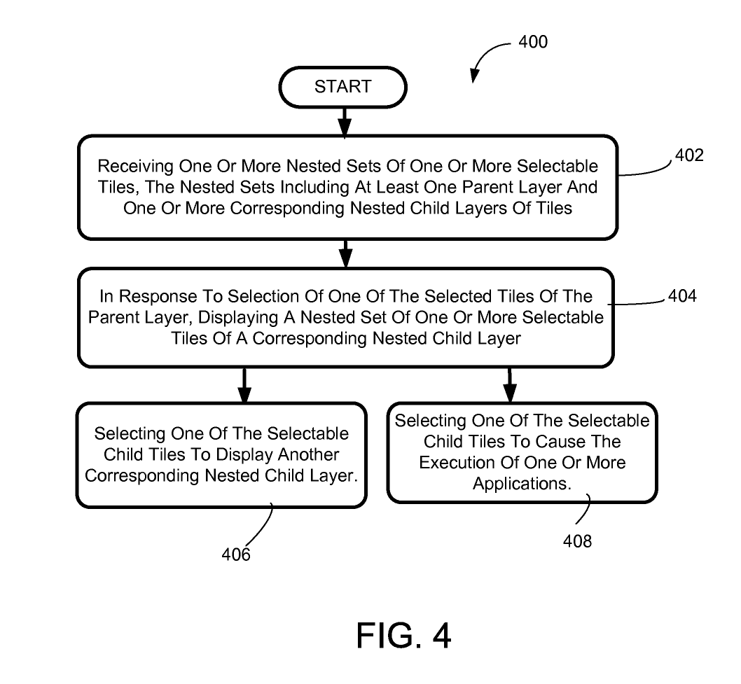

FIG. 4 depicts an exemplary computer-implemented process 400 for employing nested application containers to increase user productivity and computing efficiency. As shown in block 402, one or more nested sets of one or more selectable tiles are received. The nested sets of tiles include at least one parent layer and one or more nested child layers of tiles. A different nested child layer can be associated with each of one or more of the selectable tiles of the parent layer. The nested set of one or more selectable tiles of a corresponding nested child layer are displayed in response to the selection of one of the selectable tiles of the parent layer, as shown in block 404. In response to the selection of one of the selectable tiles of the nested child layer, a nested set of one or more selectable tiles of a further nested child layer can be displayed, as shown in block 406. This further nested child layer can contain tiles that will launch an application when selected or that can display a further nested child layer of tiles. As shown in block 408, the selection of one or more of the tiles of the child layer can cause the execution of one or more applications.

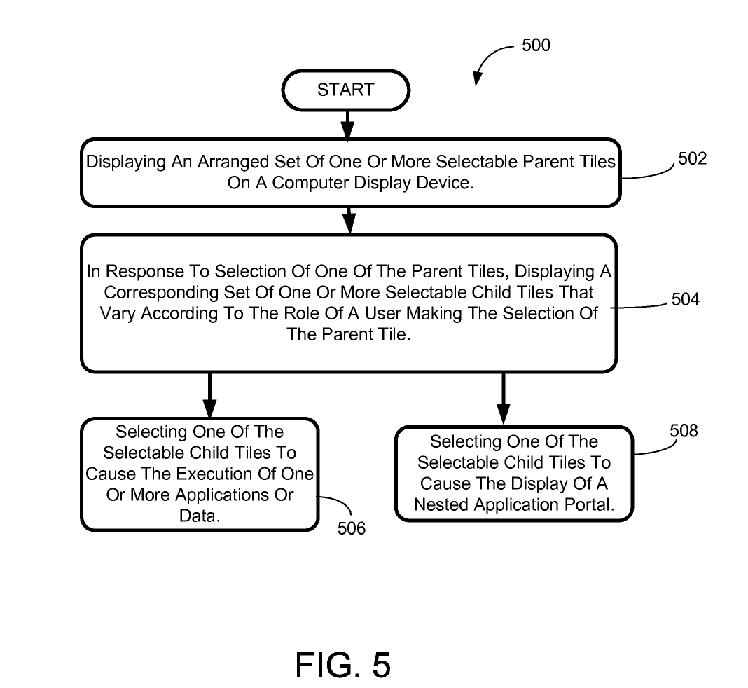

FIG. 5 depicts an exemplary computer-implemented process 500 for employing one or more application containers. This computer-implemented process 500 improves the usability of a computing system by creating a nested parent-child relationship of tiles displayed on a computer display. A start screen is displayed on a display of a computing device displays parent tiles, as shown in block 502. When an appropriate parent tile is selected a nested first child level of child tiles (e.g., an application container) is displayed, as shown in block 504. The child tiles are arranged in a grid arrangement that cannot be changed by a user. Selecting a child tile on the nested first child level can execute an app or application or display data (as shown in block 506). For example, selecting a child tile can activate an application, stream dynamic data, display static data or brings up a pinned link. Similarly, selecting a child tile on the first nested child level can display a second nested child level of tiles (a second nested application container) on the display, as shown block 508.

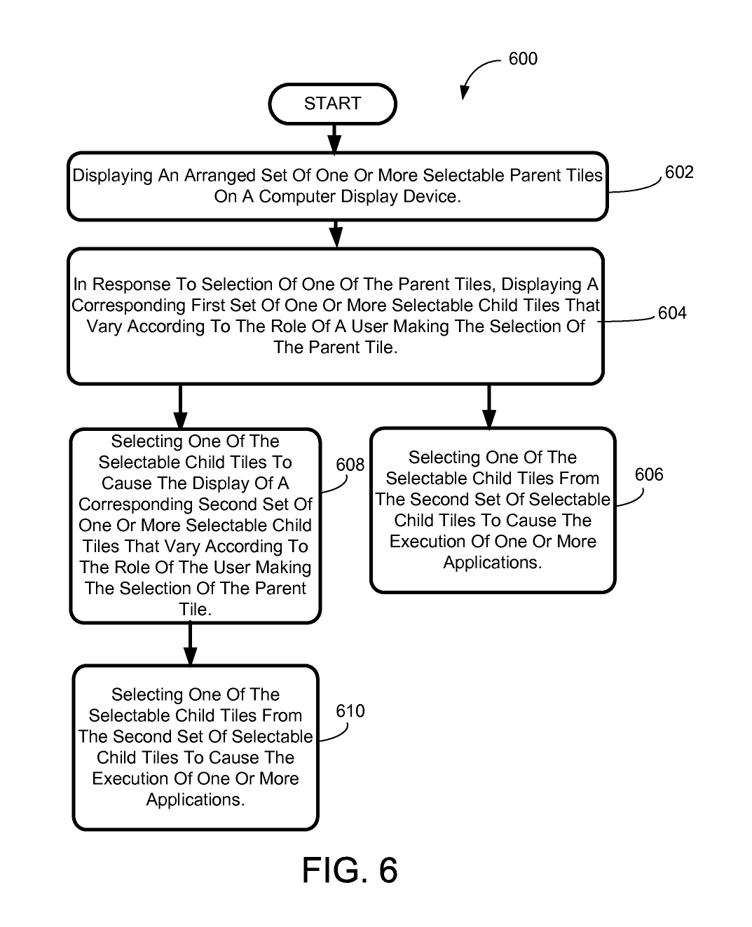

FIG. 6 depicts another exemplary computer-implemented process 600 for employing an application container to simplify user access to information and to more efficiently use computer resources. As shown in block 602, an arranged set of one or more selectable parent tiles are displayed on a computing device display. In response to the selection one of the parent tiles, a corresponding set of one or more selectable child tiles is displayed, the displayed set of tiles varying according to a role of a user making the selection of the parent tile, as shown in block 604. More specifically, the user's role or privilege level determines the child tiles that are displayed to that user. Furthermore, the role or privilege level of the user determines the type and amount of data the user has access to. Selection of one of the selectable child tiles of the first set of child tiles can cause the execution of one or more applications, as shown in block 606. Similarly, selecting a child tile from the first set of child tiles can display a second nested set of child tiles (a second nested application container) on the display, as shown block 608. The tiles of the second set of child tiles are also chosen based on the role of the user. Selecting one of the selectable child tiles from the second set of selectable child tiles can cause an execution of an application or other data (e.g., streaming data, a video, a pinned link, etc.)

### 5.0 APPLICATION CONTAINER GENERATOR

Examples of an application container can be generated by an application container generator. In general, the application container generator allows a user to design an example application container in accordance with his or her preferences and/or needs. The application container generator creates XML files that can be used to facilitate a design for building a production application container. Further customization of an application container can include resources specific to a particular organization or an industry. For example, using the application container generator, a user can build custom example application container tailored to industry, line of business, and role. Every application container can include customer branding with name and logo. Also, the user can customize tiles with a company website and applications for further personalization.

In one application container generator implementation, a user starts by selecting a “Create an example application container” button on the application container generators home screen of a computing device. From here, the user can follow a wizard to build an example application container in a short time period.

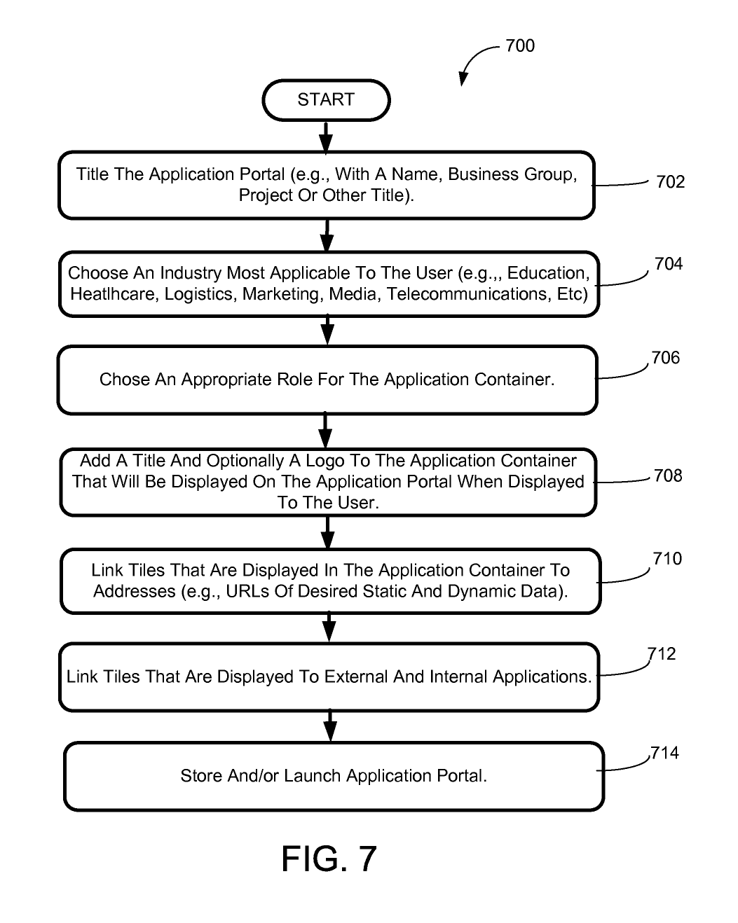

The steps of creating an application container using an exemplary implementation 700 of an application container generator shown in FIG. 7 are described in the paragraphs below.

As shown in block 702, the first step when using the application container generator is for the user to title an application container file (e.g., with a name, business group, project or other title). This title will help the user find the file in the future.

The next step in creating an example of an application container, as shown in block 704, is choosing an industry most applicable to the user. In one implementation there are six industries to choose from: Education, Healthcare, Logistics, Marketing, Media and Telecommunications. Customizable templates can be provided for each of these industries. It should be noted, however, that application containers can be designed to be used with many other industries and organizations.

Within each industry selection exists one or more roles to customize the application container, as shown in block 706. The user can select an appropriate role. Customizable templates can be provided for each of these roles.

As shown in block 708, the user can then add a title (and logo if desired) to the application container. For example, after choosing a role, the user can title the application container with a name that will appear on the application container interface. For example, this title can reflect a customer's company name, business group, department, or even be personalized down to the individual.

As shown in block 710, the user can customize tiles that are displayed in the application container. For example, the user can customize tiles to link to a social media presence and/or company URL to an editable tile grouping. Or the user can link a tile to a company's or other URL. Or an application container can be linked to an organization's media feed. In one implementation, the user is prompted to select tiles to link and to name tiles. These tiles link with crucial resource URLs to give users instant access to tools used most frequently by role. In one application container generator implementation, after selecting a specific tile, a flyout menu appears with a dialog to input an appropriate URL. Submitting this URL will link the tile to the selected resource. The selection populates the tile with an icon and label.

As shown in block 712, the user can also add links from the application container to external or internal applications. For example, in some implementations, a final editable step in creating an application container is to select hosted business applications (e.g., embedded apps) for display in the tiles of the application container. In one implementation, this step takes the user to a separate page to navigate the process, which is broken into two steps, selecting the applications and placing the applications in a desired location in the application container. In order to select the desired applications, the user navigates selection menus to choose the hosted applications most valuable to a specific customer. During this process, the user can arrange these applications by priority for an organization's needs.

Once the application container is completed, the application container can be stored and/or launched, as shown in block 714.

Some application container generator implementations include a menu option on a screen labeled ‘Your Application Containers.’ In this menu, the user will find all the previous application containers the user has created. From there he can select an application container for use or for further editing or customization.

### 6.0 EXEMPLARY OPERATING ENVIRONMENT

The application container implementations described herein are operational within numerous types of general purpose or special purpose computing system environments or configurations. FIG. 8 illustrates a simplified example of a general-purpose computer system on which various implementations and elements of application containers, as described herein, may be implemented. It is noted that any boxes that are represented by broken or dashed lines in the simplified computing device 800 shown in FIG. 8 represent alternate implementations of the simplified computing device. As described below, any or all of these alternate implementations may be used in combination with other alternate implementations that are described throughout this document.

The simplified computing device 900 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the application container implementations described herein, the device should have a sufficient computational capability and system memory to enable basic computational operations. In particular, the computational capability of the simplified computing device 800 shown in FIG. 8 is generally illustrated by one or more processing unit(s) 810, and may also include one or more graphics processing units (GPUs) 815, either or both in communication with system memory 820. Note that that the processing unit(s) 810 of the simplified computing device 800 may be specialized microprocessors (such as a digital signal processor (DSP), a very long instruction word (VLIW) processor, a field-programmable gate array (FPGA), or other micro-controller) or can be conventional central processing units (CPUs) having one or more processing cores and that may also include one or more GPU-based cores or other specific-purpose cores in a multi-core processor.

In addition, the simplified computing device 800 may also include other components, such as, for example, a communications interface 830. The simplified computing device 800 may also include one or more conventional computer input devices 840 (e.g., touch screens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 800 and with any other component or feature of application containers, including input, output, control, feedback, and response to one or more users or other devices or systems associated with application containers, are enabled by a variety of Natural User Interface (NUI) scenarios. The NUI techniques and scenarios enabled by the application containers include, but are not limited to, interface technologies that allow one or more users to interact with the application containers in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other input devices 840 or system sensors 805. Such NUI implementations are also enabled by the use of various techniques including, but not limited to, information derived from system sensors 805 or other input devices 840 from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited to, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the application container generator.

However, it should be understood that the aforementioned exemplary NUI scenarios may be further augmented by combining the use of artificial constraints or additional signals with any combination of NUI inputs. Such artificial constraints or additional signals may be imposed or generated by input devices 840 such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the application container generator.

The simplified computing device 800 may also include other optional components such as one or more conventional computer output devices 850 (e.g., display device(s) 855, audio output devices, video output devices, devices for transmitting wired or wireless data transmissions, and the like). Note that typical communications interfaces 830, input devices 840, output devices 850, and storage devices 860 for general-purpose computers are well known to those skilled in the art, and will not be described in detail herein.

The simplified computing device 800 shown in FIG. 8 may also include a variety of computer-readable media. Computer-readable media can be any available media that can be accessed by the computing device 800 via storage devices 860, and include both volatile and nonvolatile media that is either removable 870 and/or non-removable 880, for storage of information such as computer-readable or computer-executable instructions, data structures, program modules, or other data.

Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various application container generator implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware 825, hardware, or any combination thereof to control a computer to implement the disclosed subject matter. The term “article of manufacture” as used herein is intended to encompass a computer program accessible from any computer-readable device, or media.

The application container implementations described herein may be further described in the general context of computer-executable instructions, such as program modules, being executed by a computing device. Generally, program modules include routines, programs, objects, components, data structures, and the like, that perform particular tasks or implement particular abstract data types. The application container generator implementations may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

The foregoing description of the application container implementations has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate implementations may be used in any combination desired to form additional hybrid implementations of the application container generator. It is intended that the scope of the invention be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

### 7.0 OTHER IMPLEMENTATIONS

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of detailed description of the application container implementations described above.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

What is claimed is:

1. A computer-implemented process for simplifying user access to information and computing efficiency, comprising:
displaying an arranged set of one or more selectable parent tiles on a computer display device;
in response to selection one of the parent tiles, displaying a corresponding set of one or more selectable child tiles on a first child level that varies according to a role of a user.

2. The computer-implemented process of claim 1, further comprising:
selecting one of the selectable child tiles to cause the execution of an application.

3. The computer-implemented process of claim 1, wherein the child tiles are arranged in a grid arrangement that cannot be changed by a user.

4. The computer-implemented process of claim 3, wherein the grid arrangement further comprises live, static and snap tiles.

5. The computer-implemented process of claim 1, further comprising selecting a child tile on the first child level to display a second child level of tiles on the display.

6. The computer-implemented process of claim 1, wherein the parent tiles are grouped based on computing needs of the user.

7. The computer-implemented process of claim 1, wherein the role of the user determines data the user has access to.

8. The computer-implemented process of claim 2, wherein the application executes in a new window on the display.

9. The computer-implemented process of claim 1, wherein selecting a child tile streams dynamic data in a new window.

10. The computer-implemented process of claim 2, further comprising automatically generating a report based on the execution of the application.

11. The computer-implemented process of claim 1, wherein the tiles of the arranged set of selectable parent tiles and arranged set of selectable child tiles are generated using application data and user privilege data.

12. A system for simplifying user access to a multitude of programs and data displayed on a computer display, comprising:
a computing device;
a computer program comprising program modules executable by the computing device, wherein the computing device is directed by the program modules of the computer program to,
display an arranged set of parent tiles on the computer display;
when a parent tile is selected, display one or more child tiles associated with the selected parent tile that allow for the execution of one or more applications on the computer display.

13. The system of claim 12 wherein the child tiles displayed vary with a privilege level of a user.

14. The system of claim 13 wherein the privilege level of the user is determined by a directory service when the user logs on to a computer system network.

15. The system of claim 12 further comprising a module to execute one or more applications when a child tile is selected.

16. The system of claim 15, further comprising a global filter that filters data of multiple applications executing.

17. A computer-implemented process for simplifying the presentation of data and applications on a computer display, comprising,
receiving two or more nested sets of one or more selectable tiles, the nested sets including at least a parent layer and one or more nested child layers; and
displaying the nested set of one or more selectable tiles of a corresponding nested child layer in response to selection of one of the selectable tiles of the parent layer displayed on the computer display.

18. The computer implemented process of claim 17, further comprising associating a different nested child layer with each of one or more of the selectable tiles of the parent layer.

19. The computer implemented process of claim 17, further comprising associating an application with one or more of the selectable tiles of the parent layer.

20. The computer implemented process of claim 18, further comprising displaying the nested set of one or more selectable tiles of a further nested child layer in response to selection of one of the selectable tiles of the nested child layer.
